(19) United States
(12) Patent Application Publication
(10) Pub. No.: US 2018/0094984 A1
(43) Pub. Date: Apr. 5, 2018

(54) SENSING SYSTEM FOR BINS

(71) Applicant: AKRO-MILS, a Division of Myers Industries, Inc., Akron, OH (US)

(72) Inventors: Robert Sadinski, Tallmadge, OH (US); Christopher J. Clark, Akron, OH (US); Travis D. Shamp, Akron, OH (US); Scott Wiley, Medina, OH (US); Kevin R. Darrah, Medina, OH (US); Robert Ralph Scaccia, Broadview Heights, OH (US); Christopher H. Myers, Copley, OH (US); Victor J. Griswold, North Canton, OH (US)

(21) Appl. No.: 15/723,238

(22) Filed: Oct. 3, 2017

Related U.S. Application Data
(60) Provisional application No. 62/403,251, filed on Oct. 3, 2016.

(51) Int. Cl. G01J 5/10; B65D 25/02

(52) U.S. Cl. CPC G01J 5/10; B65D 25/02

(57) ABSTRACT

A sensing system for bins includes a bin with at least one light emitting diode operatively mounted to the bin. At least one receiver for detecting IR light from the at least one light emitting diode is also operatively mounted to the bin. A microcontroller is operatively connected to the at least one light emitting diode and the at least one receiver. A wireless transmitter is operatively connected to the microcontroller for relaying information regarding the content status of the bin to an indicator. The at least one light emitting diode, the at least one receiver, the wireless transmitter, and the microcontroller are operatively connected to a power source.

### CROSS-REFERENCE TO RELATED APPLICATIONS

This application claims the benefit of U.S. Provisional Patent Application Ser. No. 62/403,251, which was filed on Oct. 3, 2016.

### BACKGROUND OF THE INVENTION

### TECHNICAL FIELD

The present invention relates generally to the art of storage and transport systems. More, particularly, the present invention relates to bin systems used for storing parts and components used in conjunction with storage and/or assembly. Even more particularly, the present invention is directed to a sensing system for bins which features, at least one light emitting diode (LED) operatively mounted to the bin, at least one receiver operatively mounted to the bin for sensing IR light from the LED, a microcontroller operatively connected to the receiver for analyzing the content status of the bin based upon the inputs from the receiver, and a wireless transmitter operatively connected to the microcontroller for relaying information regarding the content status of the bin to an indicator to let an end user know when the bin is empty or nearly empty, and that the contents of the bin need to be replenished.

### BACKGROUND ART

Bin systems are often used at industrial manufacturing and warehousing sites to aid in the storing and sorting of small parts. Typically, when a bin is running low on a particular component, a worker must contact another production employee responsible for replenishing the bin to alert them of the low running stock. Alternatively, the manufacturing and warehousing site could employ a worker to periodically check the bins to determine if supply in each bin is adequate, and if not, replenish the bin with parts or components. The aforementioned manual systems of ensuring sufficient stock of component parts in a bin can be inefficient and can result in lost manufacturing time if a worker must wait for parts or components in order to resume the manufacturing process.

Some attempts have been made to implement a sensory system for electronically determining stock levels within a container. One such example is the attachment of a scale to the bottom of a bin which includes a microcontroller capable of communicating low bin levels based on measured changes in bin weight. Although such sensory systems may be sufficient when the stocked components have a significant weight, when components are light, such as with medical supplies, for example gauze, more sensitive load cells must be employed in the scale, which can significantly increase costs of the sensory system.

In another example, a single pulsed light emitter and sensor are integrated into an ice bin to determine ice levels for automatic ice making systems. When ice reaches a predetermined level, the ice interferes with the pulsed light signal, preventing the sensor from detecting the signal, which in turn communicates to the ice maker to stop making ice. Although such a system is effective in determining levels in which the ice is evenly displaced in the ice bin, the system lacks the necessary resolution to determine stock levels of bins in which components are scattered on the bottom of a bin.

Therefore, a need exists for a sensing system for bins that overcomes the problems associated with prior art sensing systems and provides a cost effective sensing system for bins which indicates bin component levels based on the spatial positioning of components, as opposed to component weight, and has sufficient resolution to determine the presence of stock components when stock levels are low and components are scattered across the bottom of the bin. The sensing system for bins of the present invention satisfies these needs, as will be described below.

This summary is provided to introduce concepts in a form that are described below in the detailed description. This summary is not intended to identify key factors or essential features of the disclosed subject matter, nor is it intended to be used to limit the scope of the disclosed subject matter.

### SUMMARY OF THE INVENTION

An objective of the present invention is to provide a bin which provides a cost effective sensing system for bins which indicates bin component levels based on the spatial positioning of components within the bin.

Another objective of the present invention is to provide a bin which provides the necessary resolution to determine the stock level of a bin in which components are scattered on the bottom of the bin when stock levels are low.

These objectives and advantages are obtained by the sensing system for bins of the present invention comprising a bin, at least one light emitting diode operatively mounted to the bin, at least one receiver operatively mounted to the bin for detecting IR light from the at least one light emitting diode, a microcontroller operatively connected to the at least one light emitting diode and the at least one receiver, a wireless transmitter operatively connected to the microcontroller for relaying information regarding the content status of the bin to an indicator, and a power source operatively connected to the at least one light emitting diode, the at least one receiver, the wireless transmitter, and the microcontroller.

### DESCRIPTION OF THE DRAWINGS

The preferred embodiment of the present invention, illustrative of the best mode in which Applicant has contemplated applying the principles of the invention, is set forth in the following description and is shown in the drawings. The following description and drawings set forth certain illustrative embodiments, aspects and implementations. These are indicative of but a few of the various ways in which one or more aspects may be employed. Further features of the invention will become apparent to those skilled in the art to which the invention relates from reading the following description with reference to the accompanying drawings, in which:

FIG. 1 is a top-front perspective view of a hanging, stackable and nestable bin;

1A is a side elevational view of the hanging, stackable and nestable bin shown in FIG. 1;

FIG. 1B is a rear elevational view of the hanging, stackable and nestable bin shown in FIG. 1;

FIG. 1C is a top plan view of the hanging, stackable and nestable bin shown in FIG. 1;

FIG. 1D is a bottom plan view of the hanging, stackable and nestable bin shown in FIG. 1;

FIG. 2A is a top perspective view of a carrier for a preferred embodiment sensing system for bins of the present invention;

FIG. 2B is a bottom plan view of the carrier shown in FIG. 2A, showing components of the sensing system attached to the bottom of the carrier;

FIG. 2C is a top plan view of the carrier for the preferred embodiment sensing system for bins shown in FIG. 2A incorporated into the hanging, stackable and nestable bin shown in FIG. 1;

FIG. 2D is a top perspective view of the carrier incorporated into the hanging, stackable and nestable bin shown in FIG. 2C with a transverse divider installed within the carrier;

FIG. 3 is a schematic diagram of the preferred embodiment sensing system for bins of the present invention, showing the operable connections between the sensing system components and a power source;

FIG. 4 is a schematic diagram of the preferred embodiment sensing system for bins of the present invention, showing the operable connections and flow of data between system components;

FIG. 5 is a top perspective view of an alternative embodiment carrier for the preferred embodiment sensing system for bins of the present invention;

FIG. 6 is a top perspective view of a second alternative embodiment carrier for the preferred embodiment sensing system for bins of the present invention incorporated into the hanging, stackable and nestable bin shown in FIG. 1;

FIG. 6A is a top perspective view of the second alternative embodiment carrier and nestable, stackable and nestable bin of FIG. 1, showing the carrier removed from the bin.

FIG. 7A is a top rear perspective view of a third alternative embodiment carrier for the preferred embodiment sensing system for bins of the present invention that is incorporated into the bin shown in FIG. 1, showing only the carrier;

FIG. 7B is a top rear perspective view of the third alternative embodiment carrier shown in FIG. 7A;

FIG. 7C is a bottom plan view of the third alternative embodiment carrier shown in FIG. 7A;

FIG. 7D is a perspective view of the LED board that is attached to the third alternative embodiment carrier shown in FIG. 7A, with the board removed from the carrier and showing the LEDs mounted on the board;

FIG. 7E is a top plan view of the LED board shown in FIG. 7D;

FIG. 7F is a side plan view of the LED board shown in FIG. 7D;

FIG. 7G is an end view of the LED board shown in FIG. 7D;

FIG. 7H is a perspective view of the receiver board that is attached to the third alternative embodiment carrier shown in FIG. 7A, with the board removed from the carrier and showing the receivers mounted on the board;

FIG. 7I is a top plan view of the receiver board shown in FIG. 7H;

FIG. 7J is a side plan view of the receiver board shown in FIG. 7H; and

FIG. 7K is an end view of the receiver board shown in FIG. 7H.

Similar numbers refer to similar parts throughout the drawings.

### DESCRIPTION OF THE PREFERRED EMBODIMENTS

The disclosed subject matter is described with reference to the drawings, in which like reference numerals are used to refer to like elements throughout the description. In the following detailed description, for purposes of explanation, numerous specific details are set forth in order to provide an understanding of the disclosed subject matter. It will be understood, however, that the disclosed subject matter can be practiced without these specific details.

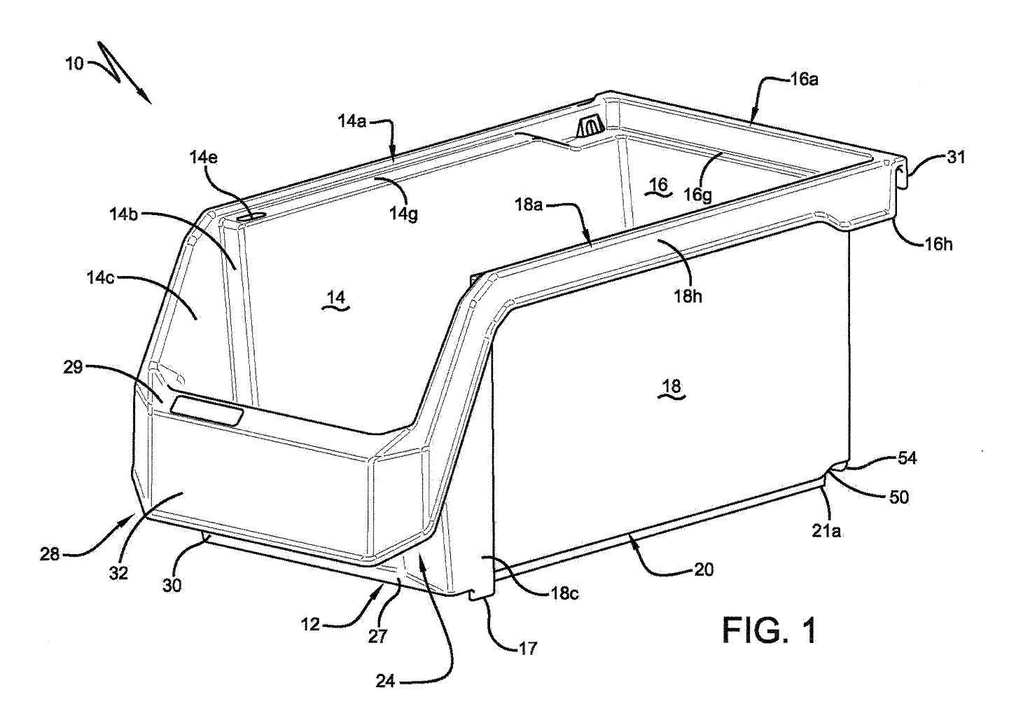

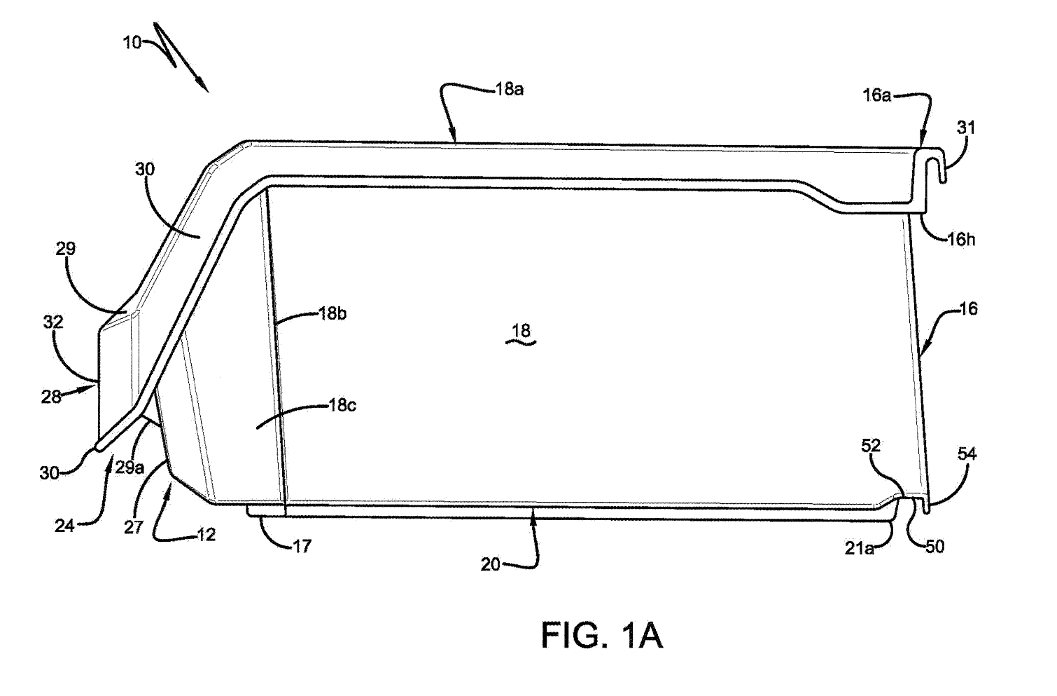

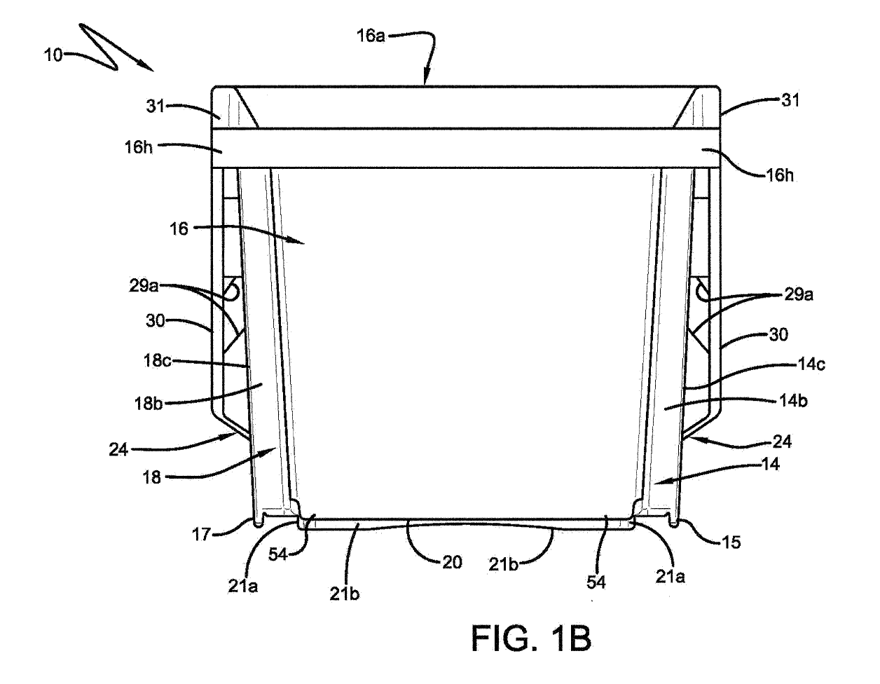

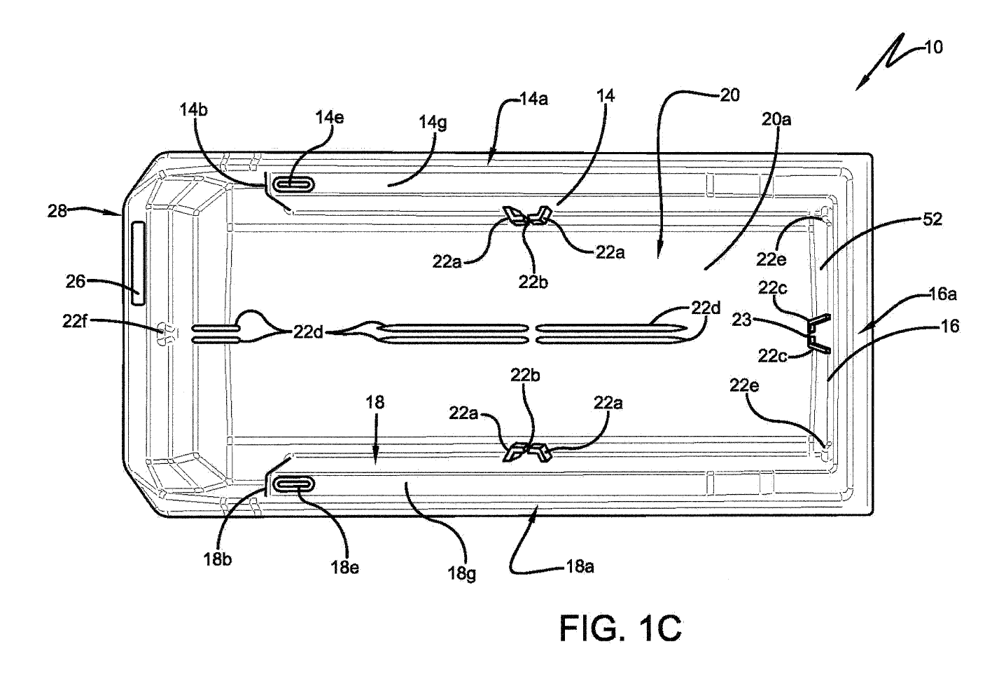

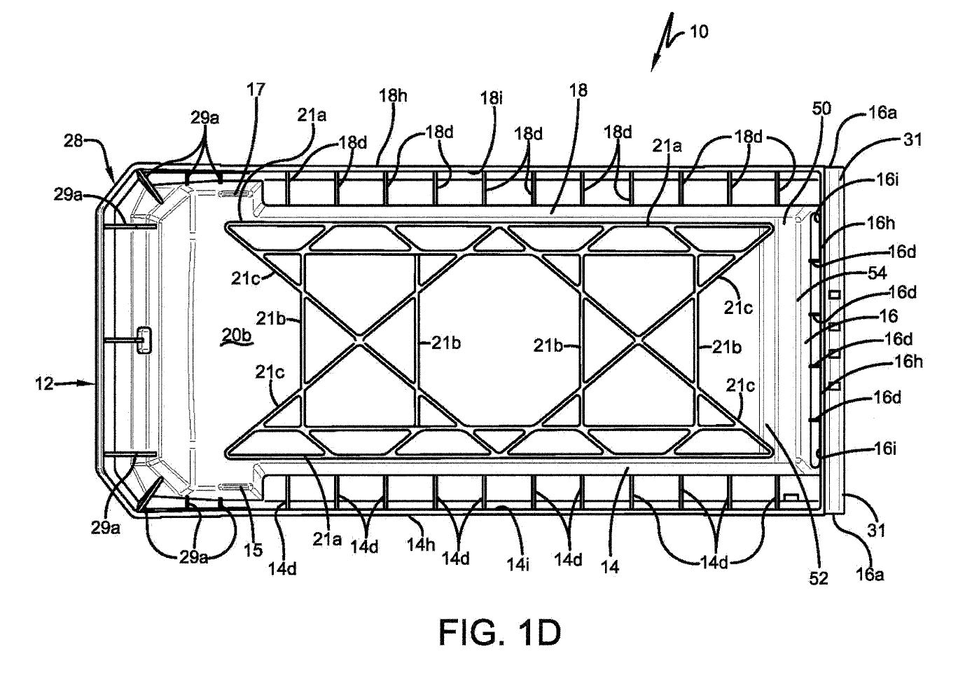

In order to better understand the sensing system for bins of the present invention, the environment in which the sensing system is utilized will now be described. A hanging, stackable and nestable bin is shown in FIGS. 1-1D, and is indicated generally at reference numeral 10. With particular reference to FIG. 1, hanging, stackable and nestable bin 10 generally includes a bin floor 20, a rear wall 16, a front wall 12, a first sidewall 14 and a transversely-spaced opposing second sidewall 18.

With continued reference to FIG. 1, front wall 12 includes a multi-faceted retaining wall 27 and a forward extending faceted hand hold 28. Handhold 28 includes an upper rim 29 and a downwardly extending overhang 30. Overhang 30 is integrally formed with, and extends downwardly from upper rim 29. A plurality of rib structures 29a extend between overhang 30 and upper rim 29 to provide support to the overhang (FIGS. 1A and 1D). Because handhold 28 is angled away from retaining wall 27, a hollow 24, representing the space between overhang 30 and retaining wall 27, allows users of bin 10 to insert their fingers into to the hollow to pull the bin towards them during use.

With particular reference to FIGS. 1-1D, first sidewall 14 generally includes an upper rim 14a, a kick out wall 14b, and a fore wall 14c. Fore wall 14c is integrally formed with retaining wall 27 of front wall 12. A footer 15 extends downwardly from, and is continuously formed with fore wall 14c. First sidewall 14 is formed slightly inwardly from upper rim 14a and fore wall 14c. First sidewall 14 includes an inner flat seating rim 14g. A footer depression 14e is formed near the front of inner flat seating rim 14g and provides stacking support for a second bin 10. Upper rim 14a includes an overhang 14h. Overhang 14h is integrally formed with, and extends outwardly and downwardly from upper rim 14a, forming a space 14i (FIG. 1D) between the overhang and the rim. As is best shown in FIG. 1D, a plurality of rib structures 14d extend between overhang 14h and upper rim 14a to provide support to the overhang. Upper rim 14a is integrally formed with handhold 28 of front wall 12. Like hollow 24, located between overhang 30 and retaining wall 27 of front wall 12, space 14i of first sidewall 14 allows users of bin 10 to insert their fingers into the space in order to aid in lifting or moving the bin.

With continued reference to FIGS. 1-1D, second sidewall 18 generally includes an upper rim 18a, a kick out wall 18b, and a fore wall 18c. Fore wall 18c is integrally formed with retaining wall 27 of front wall 12. A footer 17 extends downwardly from, and is continuously formed with fore wall 18c. Sidewall 18 is formed slightly inwardly from upper rim 18a and fore wall 18c. Second sidewall 18 includes an inner flat seating rim 18g (FIG. 1C). A footer depression 18e is formed near the front of inner flat seating rim 18g and provides stacking support for a second bin 10. Upper rim 18a includes an overhang 18h. Overhang 18h is integrally formed with, and extends outwardly and downwardly from upper rim 18a, forming a space 18i (FIG. 1D) between the overhang and the rim. As is best shown in FIG. 1D, a plurality of rib structures 18d extend between overhang 18h and upper rim 18a to provide support to the overhang. Upper rim 18a is integrally formed with handhold 28 of front wall 12. Like hollow 24 that is located between overhang 30 and retaining wall 27 of front wall 12, space 18i of second sidewall 18 allows users of bin 10 to insert their fingers into the space in order to aid in lifting or moving the bin. With particular reference to FIGS. 1, 1B, and 1C, rear wall 16 includes an upper rim 16a. Rear wall 16 is formed slightly inwardly from upper rim 16a. Rear wall 16 includes an inner flat seating rim 16g. Inner flat seating rim 16g is perpendicular to and integrally formed with each seating rim 14g,18g of first and second sidewalls 14,18, respectively, forming a continuous seating surface along the inside of the first and second sidewalls and rear wall 16. Upper rim 16a includes a downward extending overhang 16h. Overhang 16h is integrally formed with, and extends downwardly from upper rim 16a, forming a space 16i (FIG. 1D) between the overhang and rear wall 16. As is best shown in FIG. 1D, a plurality of rib structures 16d extend between overhang 16h and rear wall 16 to provide support. Upper rim 16a is perpendicular to and integrally formed with each upper rim 14a, 18a of first and second sidewalls 14,18, respectively, forming a continuous rim around preferred embodiment bin 10. Upper rim 16a includes a cleat 31 that extends downwardly from the upper rim and provides a means to hang bin 10 from a louver panel, or other similar fixture, allowing bin 10 to be elevated during use.

With particular reference to FIGS. 1C and 1D, bin floor 20 includes an interior surface 20a and an exterior surface 20b. Exterior surface 20b is formed with a plurality of longitudinal reinforcements 21a, a plurality of transverse reinforcements 21b, and a plurality of diagonal reinforcements 21c, the combination of which serves to reinforce the bin floor during high load situations. Additionally, longitudinal reinforcements 21b aid in stacking stability. With continued reference to FIG. 1C, interior surface 20a of bin floor 20 is integrally formed with the bottom of retaining wall 27 of front wall 12, the bottom of each fore wall 14c,18c of first and second sidewalls 14,18, the bottom of each first and second sidewall 14,18, and the bottom of rear wall 16. A pair of transverse divider support structures 22a are integrally formed between interior surface 20a of bin floor 20 and the inward facing surface of first sidewall 14, creating a space 22b for insertion of a transverse divider (not shown) within bin 10. A pair of transverse divider support structures 22a are also integrally formed between interior surface 20a of bin floor 20 and the inward facing surface of second sidewall 18, creating a space 22b for insertion of a transverse divider (not shown) within bin 10. A pair of longitudinal divider supports 22c are formed between interior surface 20a of bin floor 20 and the inward facing surface of rear wall 16, creating a space 23 for insertion of a longitudinal divider (not shown). A generally T-shaped slot 22f is formed in the interior surface of front wall 12 for insertion of the front end of the longitudinal divider (not shown) A plurality of divider alignment fins 22d are formed on interior surface 20a and provide additional support for the installation of a transverse divider (not shown) and a longitudinal divider (not shown). A pair of upwardly extending support structures 22e are formed at the rear of interior surface 20a, and provide support for the nesting of a second bin, as will be described in greater detail below.

With particular reference to FIG. 1A, a notch 50 is formed generally in the bottom surface of bin floor 20 extending transversely along rear wall 16. More specifically, the integral connection between bin floor 20 and rear wall 16 form an upward ridge 52 (FIG. 1D). A projection 54 extends downwardly from rear wall 16 beyond the integral connection between bin floor 20 and rear wall 16. As is best shown in FIG. 1B, projection 54 extends downwardly the longitudinal length of rear wall 16. With particular reference to FIG. 1A, notch 50 features a generally upside down U-shaped profile formed by the spatial relationship of projection 54, longitudinal reinforcements 21a, and ridge 52. The longitudinal profile of notch 50 is complementary to the longitudinal profile of upper rim 16a of rear wall 16. Because the longitudinal profile of notch 50 is complementary to the profile of upper rim 16a, when a preferred embodiment first bin 10 is stacked on top of a preferred embodiment second bin 10, notch 50 of the first bin rests on or mates with the upper rim of the second bin. With specific reference to FIGS. 1-1B, because projection 54 extends downwardly from the integral connection between bin floor 20 and rear wall 16, when the first bin notch 50 is resting on or mated with upper rim 16a on second bin, the downward projection provides stacking stability, preventing the first bin from sliding forwardly within the stacking arrangement.

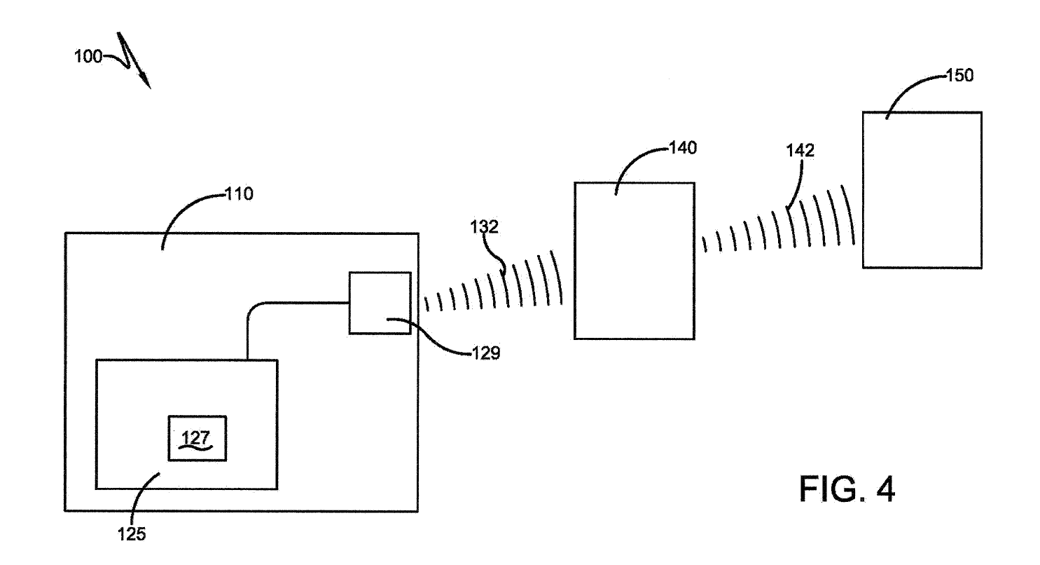

With particular reference to FIGS. 1 and 1D, footer depression 14e of seating rim 14g of first sidewall 14 features an inward geometry complementary to the outward geometry of footer 15. The complementary geometry of footer depression 14e and footer 15 enables mating of the footer of a first bin within the footer depression of a second bin during stacking, as shown in FIGS. 4 and 4A.

Likewise, each footer depression 18e (FIG. 1C) of seating rim 18g of second sidewall 18 features an inward geometry complementary to the outward geometry of each footer 17. The complementary geometry of footer depression 18e and footer 17 enables mating of the footer of a first bin within the footer depression of a second bin during stacking, as shown in FIGS. 4 and 4A. Footers 15 and 17 are transversely spaced at a distance equal to the transverse spacing between each footer depression 14e,18e of bin 10.

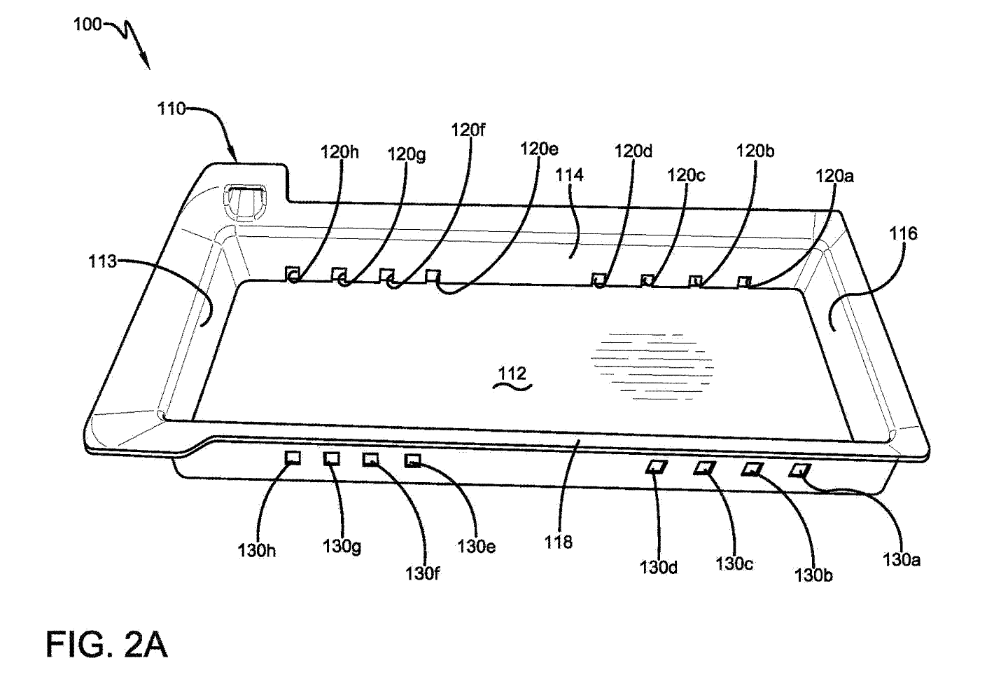

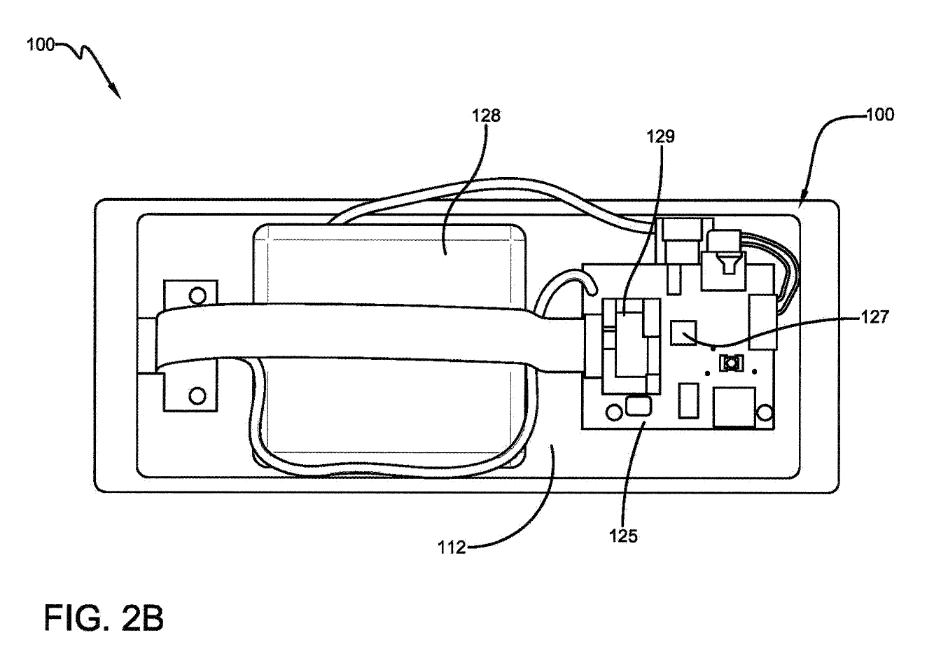

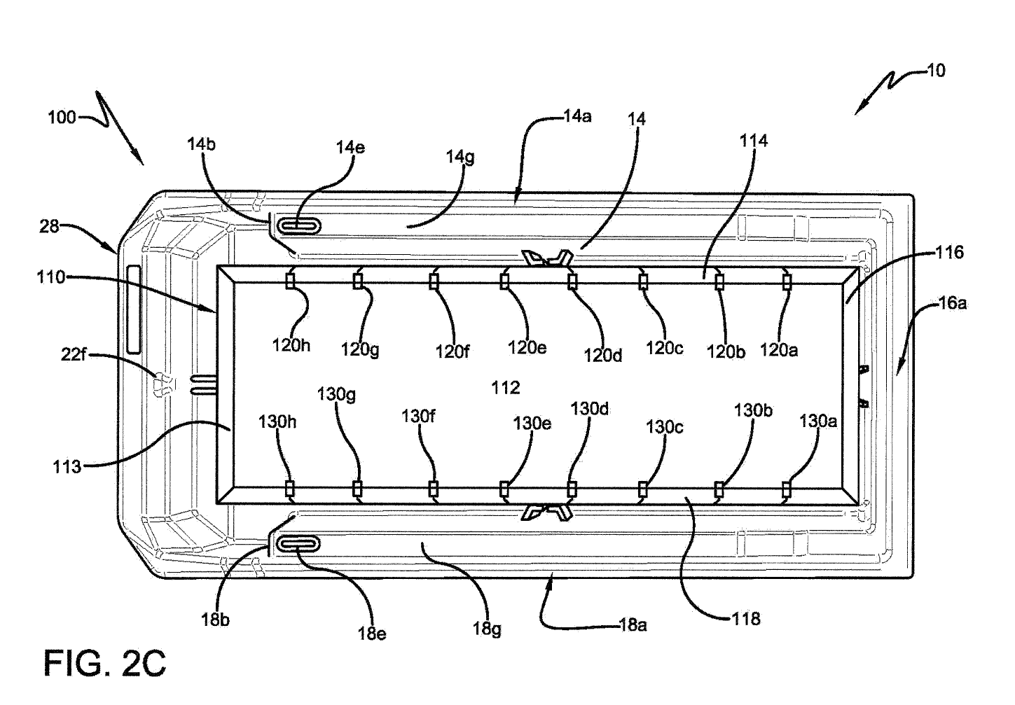

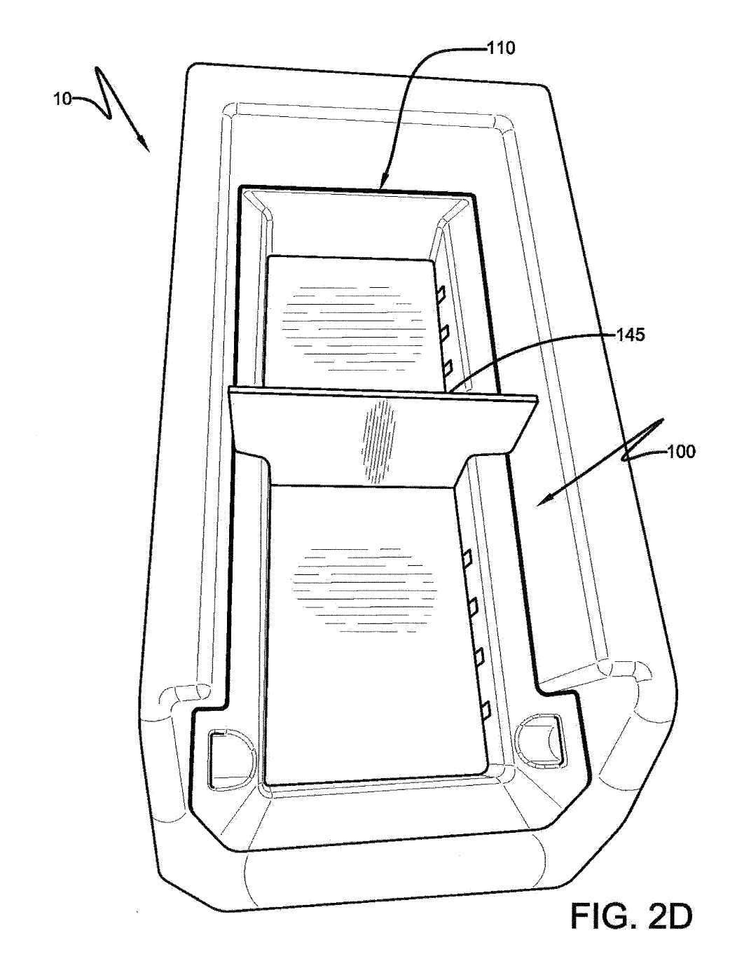

In order to better understand the sensing system for bins of the present invention, the structure of the individual system components will now be described in detail. A preferred embodiment sensing system for bins of the present invention that is incorporated into hanging, stackable and nestable bin 10, and components thereof, is shown in FIGS. 2A, 2B, 2C, 2D 3, and 4, and is indicated generally at 100. Preferred embodiment sensing system 100 includes a carrier 110. With particular reference to FIG. 2A, carrier 110 is formed with a bottom wall 112, a front wall 113, a rear wall 116, a first sidewall 114, and a transversely-spaced opposing second sidewall 118. The dimensions of carrier 110 bottom wall 112, front wall 113, rear wall 116, first sidewall 114, and second sidewall 118 are such that the carrier nests within the bottom interior space of hanging, stackable and nestable bin 10.

With reference to FIGS. 2A-2C, carrier 110 includes a plurality of LEDs 120a-120h disposed within, and attached to, a plurality of openings (not shown) formed within first sidewall 114. More specifically, the plurality of openings are positioned at distanced intervals along the longitudinal length of first sidewall 114. As LEDs 120a-120h are disposed within the plurality of openings, they too are positioned at distanced or spaced intervals along the longitudinal length of first sidewall 114. Carrier 110 includes a plurality of receivers 130a-130h disposed within, and attached to, a plurality of openings (not shown) formed in second sidewall 118. Each receiver 130a-130h are transversely spaced correspondingly opposite to a respective one of plurality of LEDs 120a-120h. A protective coating (not shown), such as a clear plastic lens or an adhesive strip, can be placed over LEDs 120a-120h and/or receivers 130a-130h to protect the LEDs and receivers from damage and to prevent contaminants such as dust and dirt from getting into the LEDs and/or receivers. With reference to FIG. 2B, carrier 110 also includes a circuit board 125 attached to the bottom surface of carrier bottom wall 112. Circuit board 125 is attached to the bottom surface of bottom wall 112 by any suitable means, such as adhesive or fasteners. As is best shown in FIGS. 2A and 2B, plurality of LEDs 120a-120h and plurality of receivers 130a-130h are operatively connected to circuit board 125. Circuit board 125 includes a microcontroller 127, the function of which will be described in greater detail below. Microcontroller 127 is an 8-bit AVR RISC-based microcontroller that includes 32 KB ISP flash memory with read-while-write capabilities, 1024B EEPROM, 2 KB SRAM, 23 general purpose I/O lines, 32 general purpose working registers, three flexible timer/counters with compare modes, internal and external interrupts, serial programmable USART, a byte-oriented 2-wire serial interface, SPI serial port, a 6-channel 10-bit A/D converter (8-channels in TQFP and QFN/MLF packages), programmable watchdog timer with internal oscillator, and five software selectable power saving modes. Microcontroller 127 operates between 1.8-5.5 volts. With reference to FIG. 2B, a wireless transmitter 129 is operatively connected to circuit board 125. Wireless transmitter 129 is an ultra-low power 2 Mbps RF transceiver for the 2.4 GHz ISM band and includes a 1.9 to 3.6 volt supply range. Alternatively, the microcontroller may be a SoC ultra-low power RF-microcontroller, which operates between 1.8-5.5 volts and includes an integrated wireless receiver, 64 KB ISP flash memory, 8.25 KB SRAM, an SPI serial port, and a 10-bit A/D converter. Alternatively, it should be understood that any suitable microcontroller may be used.

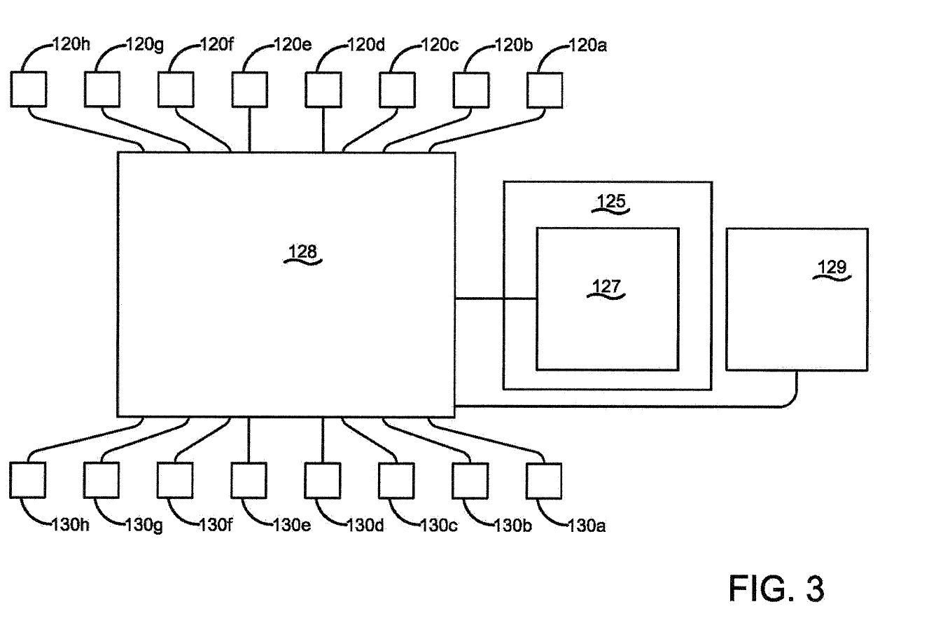

Turning now to FIGS. 2B and 3, carrier 110 includes a power source 128 to supply power to the various components of the carrier. Power source 128 is attached to the bottom surface of carrier 110 by any suitable means, such as adhesive or fasteners. Power source 128 is operatively connected to circuit board 125. Each of LEDs 120a-120h, receivers 130a-130h, microcontroller 127, and wireless transmitter 129 are in turn individually operatively connected to power source 128 via circuit board 125, the importance of which will be described in greater detail below. Preferred embodiment sensing system for bins 100 preferably operates as a 3.3 volt system. In preferred embodiment sensing system for bins 100, power source 128 utilizes 4 AA batteries (not shown), totaling 6 volts, to meet the voltage requirement of carrier 110 components: LEDs 120a-120h, receivers 130a-130h, microcontroller 127, and wireless transmitter 129. Alternatively, a plurality of different sized batteries having different voltages or even a single battery, such as a 9 volt battery, could be used to provide sufficient power to the components of preferred embodiment sensing system for bins 100.

Turning now to FIG. 4, preferred embodiment sensing system for bins 100 includes at least one store and forward device 140. Store and forward device 140 is operatively connected to wireless transmitter 129. More specifically, wireless transmitter 129 is capable of emitting a proprietary wireless communication signal 132, which in turn is received by store and forward device 140. Alternatively, circuit board 125 could be operatively connected to store and forward device 140 by other means, such as hard wiring the board to the store and forward device. With continued reference to FIG. 4, preferred embodiment sensing system for bins 100 also includes at least one bridge 150. Bridge 150 is operatively connected to store and forward device 140. In preferred embodiment sensing system for bins 100, store and forward device 140 is operatively connected to bridge 150 via a proprietary wireless communication signal 142. Alternatively, store and forward device 140 could be operatively connected to bridge 150 by other means, such as by hard wiring the store and forward device to the bridge.

Having described the structure of preferred embodiment sensing system for bins 100, the operation of the system will now be described in detail. With reference to FIG. 2A and 2C, each LED 120a-120h is capable of producing and emitting an IR signal. Each IR signal is emitted from LEDs 120a-120h as a cone shaped transmittance which is capable of reaching each of receivers 130a-130h. Each receiver is capable of detecting the presence of an IR signal emitted from LEDs 120a-120h.

In operation, each LED 120a-120h emits an IR signal in series, starting with LED 120a and cycling through LED 120b. As each individual LED 120a-120h produces and emits an IR signal, each of receivers 130a-130h also cycle through detection of a signal from the individual LED. For example, when LED 120a produces and emits an IR signal, if the signal is detected by receivers 130a-130h via their respective sensors, the receivers which have detected the signal momentarily turn on and remain on for a preprogrammed period of 40 milliseconds. The 40 millisecond period is configurable based on variables such as bin size, desired resolution, the specific type of LED used, or any other parameter of the bin sensing system. After the 40 millisecond period, an 8 bit snap-shot of detection or non-detection of the IR signal by receivers 130a-130h from LED 120a (1 bit of data per receiver) is sent to microcontroller 127 through circuit board 125. Because the detection period of receivers 130a-130b is delayed by 40 milliseconds, the probability of a false positive detection of the IR signal by the receivers is minimized, thereby providing a higher degree of accuracy in detection/non-detection data. Next, LED 120b produces and emits an IR signal. Once again, if the signal is detected by receivers 130a-130h via their respective sensors, the receivers which have detected the signal momentarily turn on and remain on for the preprogrammed period of 40 milliseconds, after which an 8 bit snap-shot of detection or non-detection of the IR signal by receivers 130a-130h from LED 120b is sent to microcontroller 127 through circuit board 125. The same pattern of emittance and detection continues through emittance of an IR signal by LEDs 120c-120h, with the associated snap-shot of detection or non-detection for receivers 130a-130h for each emittance, totaling 64 bits or 8 bytes of data sent to microcontroller 127 for the full cycle. Once each LED 120a-120h is cycled through, the pattern repeats in accordance with the aforementioned pattern, once again starting with LED 120a. The data for each snap-shot of detection or non-detection from receivers 130a-130h for each emittance from LEDs 120a-120h is sent to circuit board 125 and ultimately microcontroller 127. More specifically, if an object is blocking the path of an IR signal from reaching the particular receiver 130a-130h, the particular receiver communicates to microcontroller 127 that no signal was received. Likewise, if an object is not blocking the path of an IR signal, the particular receiver senses the IR signal via the sensor, and in turn communicates the presence of the particular signal to microcontroller 127. Microcontroller 127 in turn packetizes data from each series of emittances and detections or non-detections from each of LEDs 120a-120h to receivers 130a-130h, respectively, and forwards the packetized data as an 8 byte packet to wireless transmitter 129, as will be discussed below. It should be understood that the cycling of emittances of LEDs 120A-120h is configurable so that a full cycle could be enabled to run at any time desired by the end user. As a result, a full cycle could be initiated, for example, once every 20 minutes or once every few hours, or other required time period based upon the utilization of the contents inside the bin. As previously discussed, and with reference to FIG. 3, each of LEDs 120a-120h, receivers 130a-130h, microcontroller 127, and wireless transmitter 129 are individually operatively connected to power source 128. As a result, power can be individually drawn by each component when the component is ordered to operate via circuit board 125, and not draw power when the particular component is dormant. Because the components are each individually operatively connected to power source 128 and only draw power when in use, the life of the power source is greatly extended compared to systems in which all components are always on and thus continuously draw power.

With reference to FIG. 4, the data previously packetized by microcontroller 127 from LEDs 120a-120h and receivers 130a-130h is transferred to wireless transmitter 129, which in turn transmits the data as a proprietary wireless communication signal 132 to store and forward device 140. Although preferred embodiment sensing system for bins 100 shows only a single wireless transmitter 129 operatively connected to store and forward device 140, the store and forward device is capable of receiving and storing data from multiple wireless transmitters from different sensing systems for bins. Store and forward device 140 is capable of storing data received from wireless transmitter 129, and additional sensing systems if present, for a programmed period of time.

Store and forward device 140 ultimately transmits data received from wireless transmitter 129 to bridge 150. Once data is received from store and forward device 140 by bridge 150, the bridge processes the data to determine the presence or absence of objects within the bottom region of hanging, stackable and stackable bin 10. More specifically, bridge 150 is capable of processing all data transmitted from a cycle of emittance and signal detections/non-detection by LEDs 120a-120h and receivers 130a-130h, respectively, to create an array specifying the presence and spatial location, or absence, of components throughout the top surface of bottom wall 112 of carrier 110. The array created through data processed by bridge 150 received from a cycle of emittance and signal detections/non-detections by LEDs 120a-120h and receivers 130a-130h, respectively, provides sufficient resolution to indicate the presence and position of components scattered throughout the top surface of bottom wall 112.

Bridge 150 in turn displays when components of hanging, stackable and nestable bin 10 are in need of replenishment via communication with a visual indicator (not shown) attached to carrier 110 or hanging, stackable and nestable bin 10, such as an LED light that lights up when a certain threshold of remaining component inventory is determined.

Alternatively, bridge 150 can be integrated with central inventory control software, or client side software, at the level of the bridge for smaller systems to provide control to sensing system for bins 100. It should be understood that for larger systems, bridge 150 can be integrated with central inventory control software or client side software at a level above the bridge, in which case the bridge communicates data from store and forward device 140 to the enterprise software for control of the system. In addition, the software can be programmed to present a visual representation of the presence and spatial location, or absence, of components within the bottom of hanging, stackable and nestable bin 10 on a computer display. In such instances, software is used to pair one or more bins, each with a unique IP address, with microcontroller 127.

Next, an individual must calibrate the bin as empty by removing all components from the bin, and then setting the bin as empty through the software. For example, the software can be programmed to include a “set empty bin” button for each bin based on the bin IP address. Once, the bin is calibrated as empty, the client side software can determine the percentage above empty of the bin based on data received by bridge 150 from store and forward device 140 and bins linked thereto, such as by calculating the percentage of IR signals actually detected by receivers 130a-130h for each snap-shot from a series of emittances from LEDs 120a-120h divided by the total possible detectable signals at empty. It should be understood that the “set empty bin” button can be tuned or configured at the calibration stage to recognize conditions of the bin other than completely empty, by calibrating or tuning the “set empty bin” button at a time when the bin still contains some components. Thus, the software would see the bin as being empty when the particular calibrated or tuned empty threshold is met rather than when the bin is actually completely empty. The software could also be programmed to provide for alarm levels based on visual displays on a computer screen, such as a graphic assigned to each bin IP address. The graphic in turn can provide bin status based on a color to signal the relative amount of contents in the bin. For example, the graphic can be colored green when the bin percent empty is 85 percent or above, yellow when the bin percent empty is at 40 percent to 84 percent, and red in instances where the bin percent empty is below 40 percent. The software can also be custom programmed to provide additional data, such as battery voltage of power source 128.

In addition, and with reference to FIG. 2D, a divider 145 can be placed within hanging, stackable and nestable bin 10 to separate the bin into two discrete compartments. In such instances, the software is capable of determining the presence of a divider based on an algorithm applied to the packetized data received from microcontroller 127. The software in turn can be custom programmed to provide an independent percentage empty readout for each discrete compartment of the bin, including use of the aforementioned graphic colors to indicate stock levels of each compartment on a split graphic.

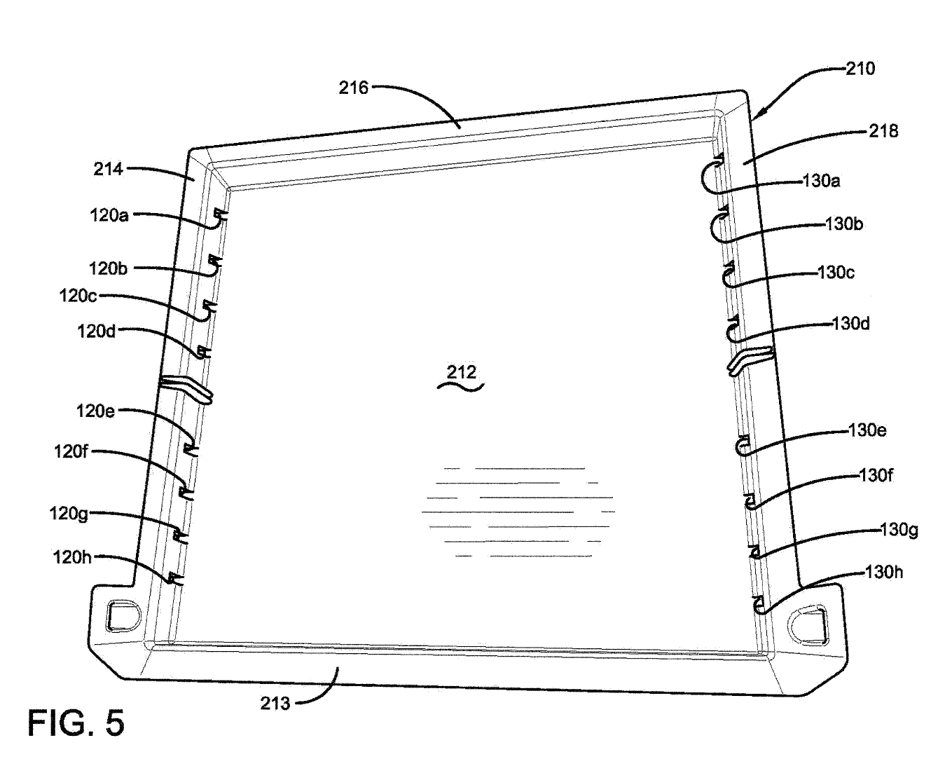

An alternative embodiment carrier is shown in FIG. 5, and is indicated generally at reference numeral 210. Carrier 210 is similar in structure and function to carrier 110, except that carrier 210 has a different structure and is formed to nest within the bottom of a bin (not shown) with wider dimensions compared to hanging, stackable and nestable bin 10. Carrier 210 is formed with a bottom wall 212, a front wall 213, a rear wall 216, a first sidewall 214, and a transversely-spaced opposing second sidewall 218. Carrier 210 includes a plurality of LEDs 220a-220h disposed within, and attached to, a plurality of openings (not shown) formed within first sidewall 214. More specifically, the plurality of openings are positioned at distanced intervals along the longitudinal length of first sidewall 214. As LEDs 220a-220h are disposed within the plurality of openings, they too are positioned at distanced intervals along the longitudinal length of first sidewall 214. Carrier 210 includes a plurality of receivers 230a-230h disposed within, and attached to, a plurality of openings (not shown) formed in second sidewall 218. Each receiver 230a-230h is transversely spaced correspondingly opposite to a respective one of plurality of LEDs 220a-220h. The operation of carrier 210 is generally identical to the operation of carrier 110 described in detail above.

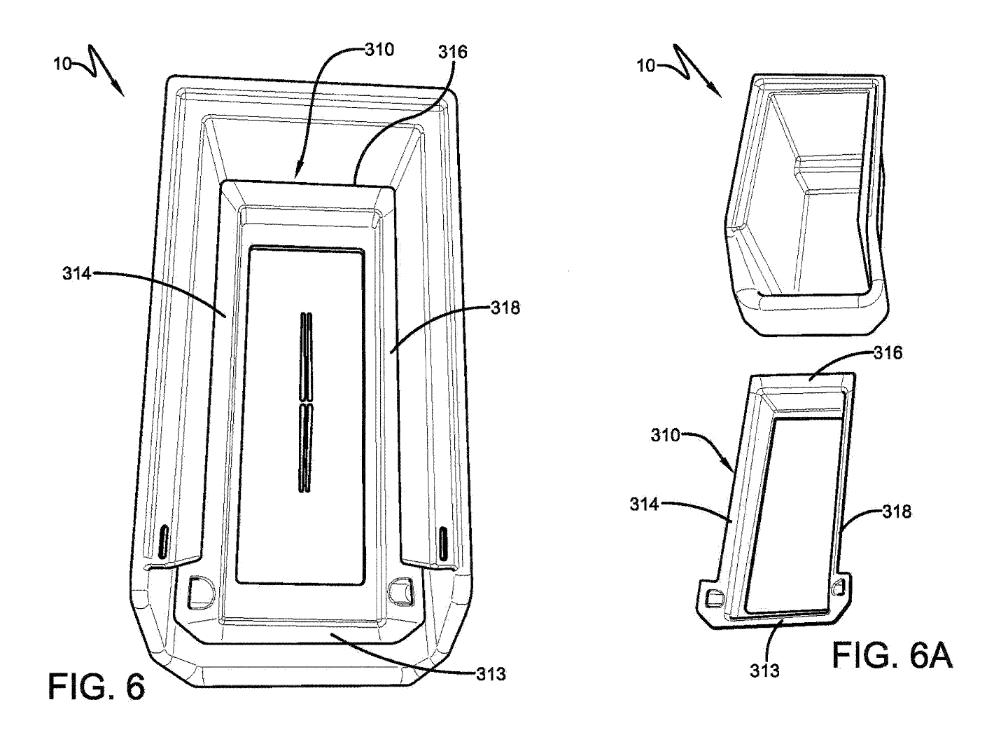

A second alternative embodiment carrier 310 is shown in FIGS. 6 and 6A. Carrier 310 is similar in function to carrier 110, except that carrier 310 has a different structure and requires an alternative positioning of circuit board 125, radio transmitter 129, microcontroller 127, and power source 128 relative to the carrier. More specifically, carrier 310 is formed with a front wall 313, a rear wall 316, a first sidewall 314, and a transversely-spaced opposing second sidewall 318, but lacks a bottom wall, as present in carrier 110. Sidewalls 314,318 are formed with a plurality of openings similar to first embodiment carrier 110 for placement of LEDs (not shown) and receivers (not shown). Because carrier 310 lacks a bottom wall, consequently, the circuit board (not shown), radio transmitter (not shown), microcontroller (not shown), and power source (not shown) of carrier 310 are attached to the carrier between the carrier and the interior surface of hanging, stackable and nestable bin 10 first sidewall 14, rear wall 16, and/or second sidewall 18. Because carrier 310 does not include a bottom wall with the circuit board, radio transmitter, microcontroller, and power source attached to the bottom surface thereof, more space for storing components is available within hanging, nestable and stackable bin 10.

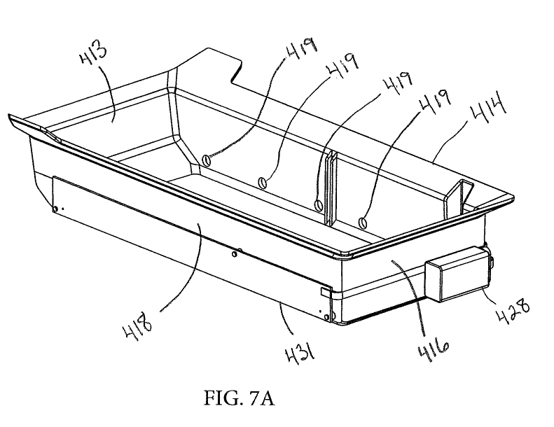

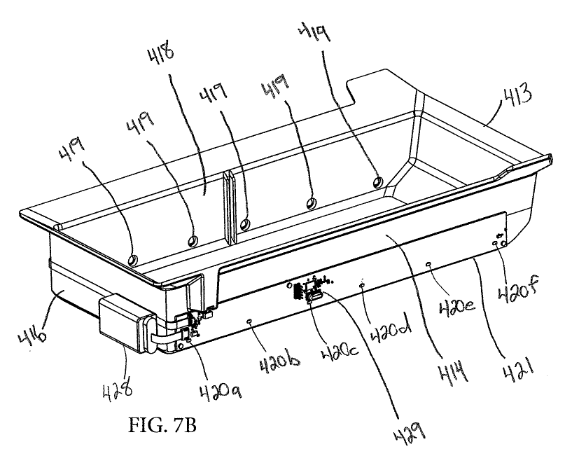

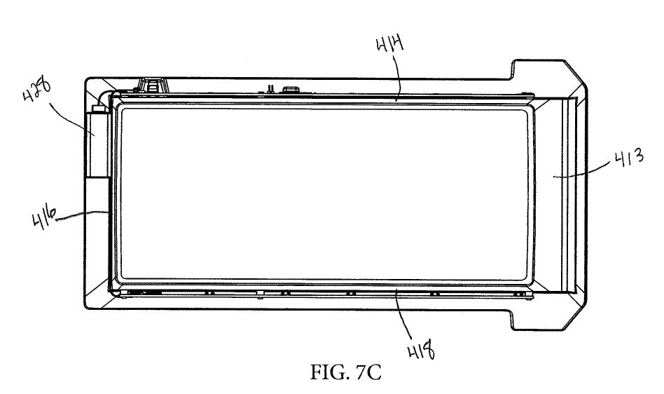

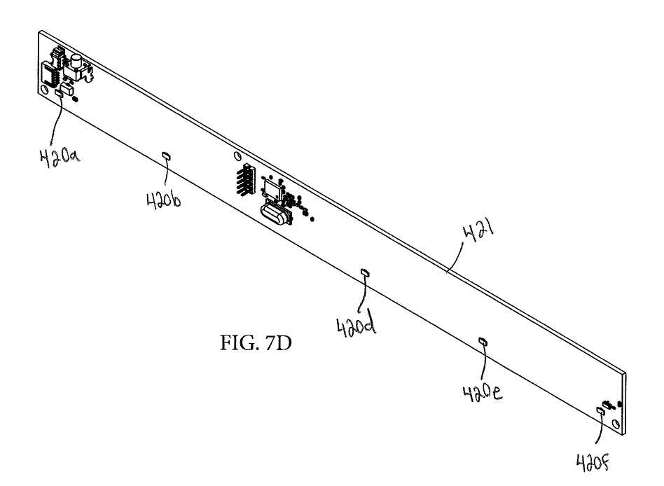

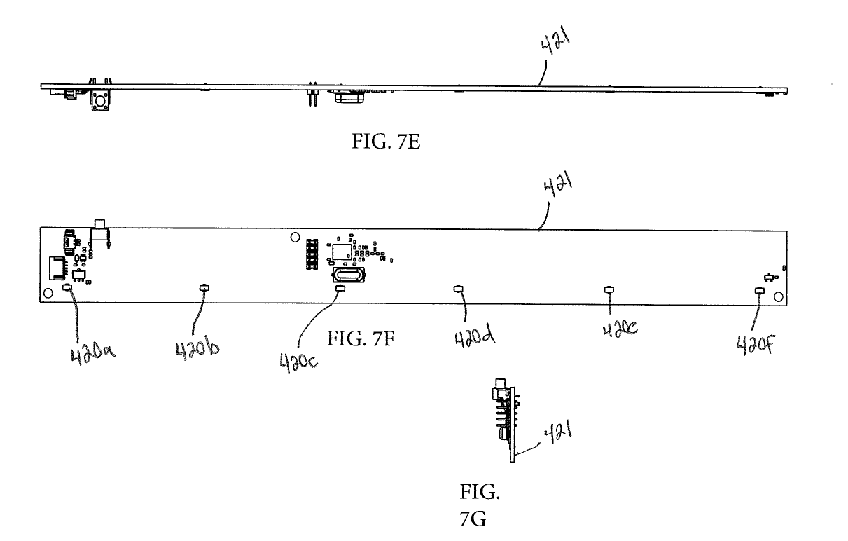

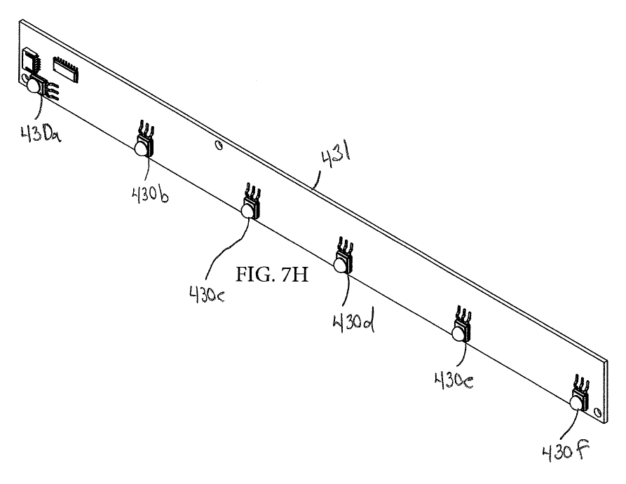

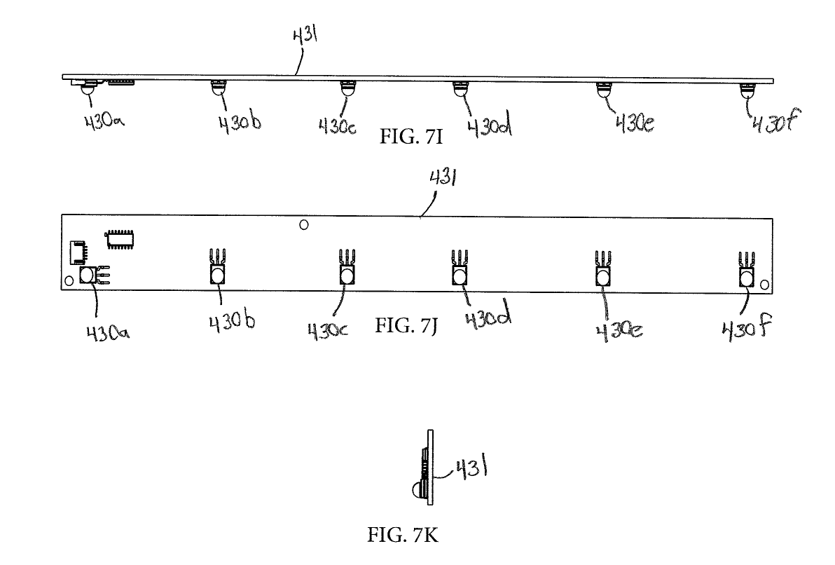

A third alternative embodiment carrier 410 is shown in FIGS. 7A-7K. Carrier 410 is similar in function to carrier 110, except that carrier 410 has a different structure and requires an alternative positioning of a circuit board 425, radio transmitter 429, microcontroller 427, and power source 428 relative to the carrier. More specifically, carrier 410 is formed with a front wall 413, a rear wall 416, a first sidewall 414, and a transversely-spaced opposing second sidewall 418, but lacks a bottom wall, as is present in carrier 110. Sidewalls 414,418 are formed with a plurality of openings 419. A plurality of LEDs 420a-420f are mounted on an LED board 421. A plurality of receivers 430A-430f are mounted on a receiver board 431. Because carrier 410 lacks a bottom wall, consequently, LED board 421, receiver board 431, wireless transmitter 429, microcontroller (not shown), and power source 428 of carrier 410 are attached to the carrier between the carrier and the interior surface of hanging, stackable and nestable bin 10 first sidewall 14, rear wall 16, and/or second sidewall 18. Because carrier 410 does not include a bottom wall containing the circuit board, radio transmitter, microcontroller, and power source attached to the bottom surface thereof, more space for storing components is available within hanging, nestable and stackable bin 100 when carrier 410 is utilized.

It is contemplated that carriers 110,210,310,410 could have different shapes/structures and dimension allowing preferred embodiment sensing system 100 of the present invention to be utilized with bins of varying shapes and/or sizes, without affecting the overall concept of the invention. It is also contemplated that LEDs 120,420 and receivers 130,430 could be positioned in different positions relative to hanging, stackable and nestable bin 10, such as a front-to-back, back-to-front and side-to-side orientation relative to the bin or carrier, without affecting the overall concept or operation of the present invention. It is also contemplated that LEDs 120,420, receivers 130,430, microcontroller 127, power source 128,428 or wireless transmitter 129,429 could be mounted directly to the bin or on an intermediate board, without changing the overall concept or operation of the present invention. It is further contemplated that one or more resistors of varying resistivity could be incorporated into circuit board 125,421,431 to decrease or alter the intensity of the IR signal emitted from LEDs 120a-120h,420a-420f in order to optimize resolution of sensing system for bins 10 depending on the spacing between the LEDs and receivers 130,430, without affecting the overall concept of the invention. It is further contemplated that more or less LEDs and corresponding receivers could be utilized with sensing system 100. For example, a second set of LEDs and receivers could be positioned above LEDs 120a-120h and receivers 130a-130d to enable detection of component positioning depth within the bin, without affecting the overall concept of the invention. It also contemplated that different operative connections could be utilized between components of preferred embodiment sensing system 100, such as hard wired connections, without affecting the overall concept of the invention. It is also contemplated that sensing system for bins 100 could be integrated with, and controlled by, a hard wired server without affecting the overall concept of the invention. It is also contemplated that sensing system bins 10 could be integrated with, and controlled by, a cloud based server without affecting the overall concept of the invention. It is also contemplated that the components may be mounted to the bin directly.

From the above description of at least one aspect of the invention, those skilled in the art will perceive improvements, changes and modifications. Such improvements, changes and modifications within the skill of the art are intended to be covered by the description.

Certain terminology is used herein for purposes of reference only, and thus is not intended to be limiting. For example, terms such as “upper”, “lower”, “above”, and “below” refer to directions in the drawings to which reference is made. Terms such as “left”, “right”, “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary aspects, the articles “a”, “an” and “the” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

Although the description has been shown and described with respect to one or more embodiments, aspects, applications or implementations, it will occur to those skilled in the art based upon a reading and understanding of this description and the drawings that equivalent alterations and modifications may be made without detracting from the spirit and scope of the embodiments, aspects or implementations in the description. The description and claims are intended to include all such modifications and alterations.

The present invention has been described with reference to a specific embodiment. It is understood that this description and illustration is by way of example and not by way of limitation. Potential modifications and alterations will occur to others upon a reading and understanding of this disclosure, and it is understood that the invention includes all such modifications and alterations and equivalents thereof.

What is claimed is:

1. An object sensing system for bins comprising:
a bin;
at least one light emitting diode operatively mounted to the bin;
at least one receiver operatively mounted to the bin for detecting IR light from the at least one light emitting diode;
a microcontroller operatively connected to the at least one light emitting diode and the at least one receiver;
a wireless transmitter operatively connected to the microcontroller for relaying information regarding the content status of the bin to an indicator; and
a power source operatively connected to the at least one light emitting diode, the at least one receiver, the wireless transmitter, and the microcontroller.

2. The object sensing system for bins of claim 1, further comprising a store and forward device operatively connected to said wireless transmitter.

3. The object sensing system for bins of claim 2, further comprising a bridge operatively connected to the store and forward device.

4. The object sensing system for bins of claim 1, said bin further comprising a carrier operatively mounted to the bin.

5. The object sensing system for bins of claim 4, wherein said carrier is operatively connected to the at least one light emitting diode, the at least one receiver, the microcontroller, and the power source.

6. The object sensing system for bins of claim 4, wherein said carrier nests within the bottom interior space of the bin.

7. The object sensing system for bins of claim 1, wherein said operative mounting of the at least one light emitting diode to the bin comprises said at least one light emitting diode being directly mounted to the bin.

8. The object sensing system for bins of claim 4, wherein said operative mounting of the at least one light emitting diode to the bin comprises the at least one light emitting diode mounted to said carrier.

9. The object sensing system for bins of claim 1, wherein said at least one light emitting diode includes a plurality of light emitting diodes.

10. The object sensing system for bins of claim 1, wherein said at least one receiver includes a plurality of receivers.

11. The object sensing system for bins of claim 1, wherein said bin includes a removable transverse divider for separating the bin into two discrete compartments.

12. The object sensing system for bins of claim 1, wherein said power source comprises at least one battery.

13. The object sensing system for bins of claim 1, wherein said power source is individually operatively connected to each of the at least one light emitting diode, the at least one receiver, the wireless transmitter, and the microcontroller.

14. The object sensing system for bins of claim 3, wherein said bridge is integrated with a central inventory system.

15. The object sensing system for bins of claim 1, further comprising a circuit board operatively connected to the microcontroller.

16. The object sensing system for bins of claim 9, wherein said plurality of light emitting diodes are spaced from one another along a sidewall of said bin.

17. The object sensing system for bins of claim 10, wherein said plurality of receivers are spaced from one another along a sidewall of said bin,

18. The object sensing system for bins of claim 9, wherein said at least one receiver includes a plurality of receivers, each one said plurality of receivers sensing the plurality of light emitting diodes.
